(19) United States
(12) Patent Application Publication
(10) Pub. No.: US 2006/0229951 A1
(43) Pub. Date: Oct. 12, 2006

(54) System and method for information handling system build-to-order packaging

(76) Inventors: Timothy Abels, Pflugerville, TX (US); Peyman Najafirad, Austin, TX (US)

Correspondence Address: HAMILTON & TERRILE, LLP, P.O. BOX 203518, AUSTIN, TX, 78720, US

(21) Appl. No.: 11/103,192

(22) Filed: Apr. 11, 2005

(51) Int. Cl. G06Q 30/00

(52) U.S. Cl. 705/26

(57) ABSTRACT

Built-to-order products, such as information handling systems, are packaged-to-order based on user preferences for reduced packaging waste. The user is presented packaging options at an order for one or more information handling systems and selects desired options, such as excluding recovery media, application media and user manuals. For instance, a corporate user ordering plural information handling systems has the user manual included in only one package, excludes recovery CDs and elects to have a recovery image with applications electronically available over the Internet, such as with the entry of license keys. Selected options are saved as a packaging policy associated with the user for use with subsequent orders by the user.

### BACKGROUND OF THE INVENTION

1. Field of the Invention

The present invention relates in general to the field of information handling system manufacture and shipping, and more particularly to a system and method for information handling system build-to-order packaging.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Information handling systems may have a wide variety of hardware and software components that are configured for accomplishing desired functions. For instance, desktop systems are built with processors of varying speeds to balance cost with information processing capacity. A system used by a secretary for word processing generally needs less processing power and thus a less expensive processor than a system used by a gamer. Similar adjustments to the memory, drives, buses, operating system and other components allow individuals to focus the configuration of an information handling system to meet specific needs within desired cost constraints. In order to fully take advantage of the flexibility available for information handling system configurations, consumers have increasingly turned to build-to-order manufacturers. In the build-to-order process, a consumer selects from available hardware and software components to define a system configuration in a manifest and the manufacturer builds the system from the manifest. Typically, the physical components are assembled, an image having the software components is copied to the information handling system, and then the completed system is shipped direct from the manufacturer to the consumer. Often customers who order numerous systems use the same or similar configurations for consistency and to ensure interoperability. For example, an information technology administrator typically orders multiple server systems at a time for assembly in a server rack.

One disadvantage of build-to-order manufacturing is the expense and complexity of shipping manufactured information handling systems to consumers. An information handling system generally must be securely packaged to avoid damage during shipment. In addition, each information handling system typically includes accessories for use upon delivery, such as set up instructions, a recovery disk, application disks, and hardware for assembly, such as server rack rails. Proper packaging improves the customer experience and reduces the likelihood of expensive service calls, such as where a needed set of instructions or piece of hardware is missing. However, excessive packaging sometimes leads to consumer confusion, adds to system costs, and results in waste. As one example, information handling systems are typically packaged with a recovery CD that a consumer may use to reload the operating system and applications in the event of a system failure. Recovery CDs are typically created from the build-to-order manifest to ensure that a recovery will bring the information handling system to its original manufacture state. Where a business orders quantities of similarly-configured systems, recovery CDs are typically not needed. Other examples of unneeded materials include bezels, rails and owner manuals.

### SUMMARY OF THE INVENTION

Therefore a need has arisen for a system and method which adjusts packaging materials used to package a product such as an information handling system.

In accordance with the present invention, a system and method are provided which substantially reduce the disadvantages and problems associated with previous methods and systems for packaging information handling systems. Package-to-order options are presented to a user for selection of packaging material used to package a product ordered by the user, such as exclusion of one or more materials selectively deemed by the user as duplicative or unnecessary. For instance, a user selectively excludes optional packaging materials from one or more products of a multiple product order.

More specifically, an order site includes a configuration engine and a packaging engine interfaced with a network, such as the Internet. A user interfaces through the network with the configuration engine to define a configuration of components for an information handling system. The user interfaces with the packaging engine to selected one or more optional packaging preferences. The configuration and packaging preferences are sent in a manifest to a manufacture site where the information handling system is built-to-order. The information handling system proceeds with the manifest to a packaging site for packaging-to-order according to the packaging preferences. One example of a packaging preference is the exclusion of one or more packaging materials, such as a recovery media or a user's manual, from one or more of an order for plural information handling systems. Thus, for instance, a corporate user who orders plural similarly-configured information handling systems receives a single user's manual with one information handling system that the user has available for the other systems of the order. Alternatively, the corporate user selects as a packaging preference the exclusion of a recovery CD in favor of a recovery image available on-line from the manufacture. Once packaging preferences are selected, subsequent orders from the user associated with the packaging preferences may automatically apply the packaging preferences until reset by the user.

The present invention provides a number of important technical advantages. One example of an important technical advantage is that information handling system packaging-to-order addresses the needs of the consumer without excess miscellaneous packaging material. Certain core packaging materials are defined that are required for inclusion in each package, such as legal and safety information. Beyond the core packaging materials, a consumer defines optional packaging materials for inclusion with a shipped information handling system. For example, an information technology administrator eliminates recovery CDs from shipped information handling systems because the administrator already has a recovery image for the systems. The administrator avoids the waste of a recovery CD included with each system and the manufacturer reduces the packaging cost by manufacturing fewer recovery CDs. This improves the user experience and gives the administrator better control over the orders placed. By selecting packaging options as a policy, the administrator automatically enforces selected options on subsequent orders.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 depicts a block diagram of a system for ordering built-to-order information handling systems packaged-to-order; and

FIG. 2 depicts a flow diagram of a process for packaging information handlings systems to order.

### DETAILED DESCRIPTION

Package-to-order of information handling systems extends the build-to-order process to packaging and shipment or completed systems for an improved user experience, reduced cost and greater environmental sensitivity. For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/0) devices, such as a keyboard, a mouse, and a video display. The information handling system may also include one or more buses operable to transmit communications between the various hardware components.

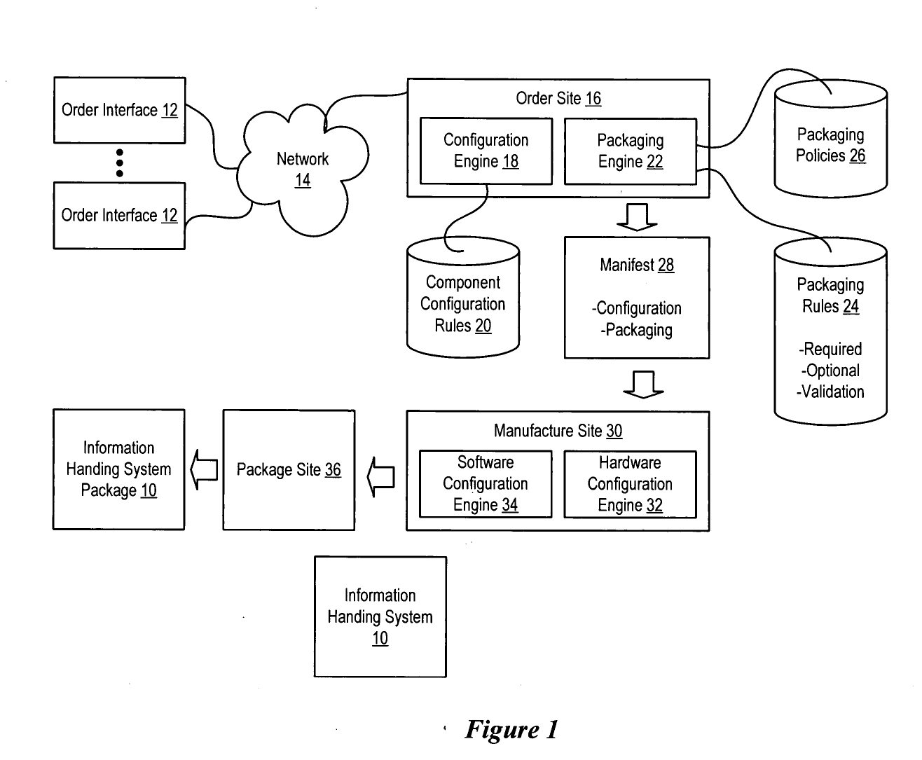

Referring now to FIG. 1, a block diagram depicts a system for ordering built-to-order information handling systems 10 packaged-to-order. Information handling system orders are placed at an order interface 12 interfacing through a network 14, such as the Internet, with an order site 16, such as a web site. A configuration engine 18 presents configuration options to order interfaces 12 in accordance with component configuration rules 20. For instance, a corporate information handling system purchaser selects desired processing, memory and drive components to have assembled into one or more information handling systems. Along with product configuration selections provided by configuration engine 18, order site 16 provides product packaging options to order interface 12 through a packaging engine 22. Packaging engine 22 presents packaging options based on packaging rules 24 that define available packaging preferences as required, optional and for validation of selections made by a user. Once a user selects packaging preferences, these are saved as packaging policies 26 for user or reference in subsequent product orders by the user.

Configuration selections and packaging selections made at order site 16 are used to generate a manifest 28 for reference in the manufacture and shipping of the ordered information handling systems. For instance, manifest 28 lists the SKU codes for selected components and selected packaging options. A manufacture site 30 has a hardware configuration engine 32 that guides the building of the physical components in an assembled system and a software configuration engine 34 that guides the loading of the operating system and application components into permanent memory. Once an information handling system 10 is completed, a packaging site 36 receives the information handling system where the packaging of the information handling system is performed according to the packaging selections of manifest 28. The packaged information handling system 10 is then shipped to the customer. Packaging options are identified by subparts of a SKU for each manifest and may include excluding a packaging material, such as a recovery medium or user's manual, using electronic alternatives to packaging materials, such as a recovery image or user's manual available through the Internet, or a variety of destination, storage and delayed shipping selections. Packaging engine 22 automatically includes required packaging materials on manifest 28 for each product, such as safety information, without selection by the user. Optional packaging materials are selectable on a per-order basis, on a policy-basis that manages plural orders, or with a combination of such selections. A “core” option includes only the required packaging material and excludes the optional materials.

An example of a package-to-order selection is the ordering of multiple similarly-configured information handling systems with only selected of the systems packaged with a recovery disc or user's manual. Another example of a package-to-order selection is the ordering of selected spare parts, such as hardware for bezels or rails, with some but not all systems. In some instances, packaging materials are excluded from all ordered systems, such as by providing on-line access to software and license keys to avoid including media having applications in the packaging. Packaging preferences may be presented with role-based attributes that vary depending on the authority of an individual, time-based attributes that allow delayed manufacture or shipping, destination-based attributes, or content-based attributes. Component manufacturers interfaced with the packaging rules may add extensible hooks for additional packaging services, such as updated on-line content or spare parts. The validation rules resolve packaging preference conflicts with product dependencies, legal requirements, environmental requirements, security, quality control and cost.

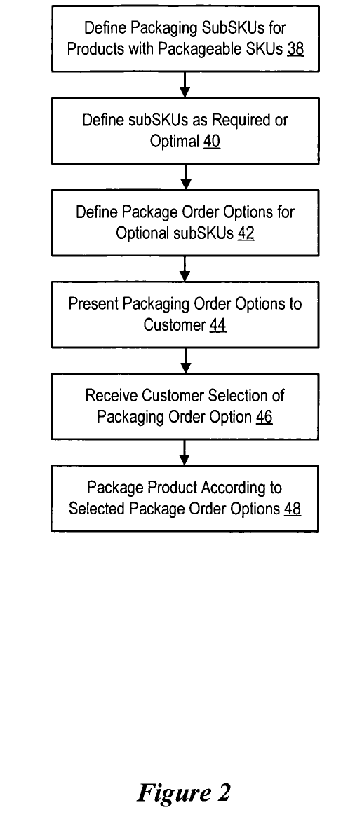

Referring now to FIG. 2, a flow diagram depicts a process for packaging information handlings systems to order. The process begins at step 38 with the defining of packaging subSKUs for products having packageable SKUs. At step 40, the subSKUs are defined as required or optional. At step 42, packaging order options are defined for the optional subSKUs to present the associated packaging materials to the user for selection. At step 44, the packaging options are present to a customer for selection of packaging materials. At step 46, the customer inputs the selection options and the associated subSKUs are added to the product manifest. At step 48, the product is packaged by reference to packaging options selected on the manifest and then shipped to the customer.

Although the present invention has been described in detail, it should be understood that various changes, substitutions and alterations can be made hereto without departing from the spirit and scope of the invention as defined by the appended claims.

What is claimed is:

1. A system for packaging a product, the product having plural components, the components selected by a user, the system comprising:
an order site having a configuration engine operable to create a manifest for the product, the manifest defining one or more components according to user selections and component configuration rules, the order site further having a packaging engine operable to define one or more user selected packaging materials on the manifest;
packaging rules interfaced with the packaging engine, the packaging rules defining optional and required packaging materials;
a manufacture site operable to assemble the components of the manifest into the product; and
a packaging site operable to package the assembled product according to the packaging materials of the manifest.

2. The system of claim 1 wherein the product comprises an information handling system.

3. The system of claim 2 wherein the optional packaging materials comprise an owner's manual.

4. The system of claim 2 wherein the optional packaging materials comprise a recovery disc.

5. The system of claim 2 wherein the required packaging materials comprise safety information.

6. The system of claim 1 wherein the packaging engine is further operable to define one or more packaging policies associated with one or more users, the packaging policies defining selected of the optional packaging materials for inclusion in each manifest.

7. The system of claim 6 wherein a packaging policy comprises a periodic product order having selected of the optional packaging materials.

8. The system of claim 1 wherein the packaging rules further comprise validation rules, the packaging engine further operable to apply the validation rules to validate selected packaging options.

9. A method for packaging a product, the method comprising:
receiving from a user an order for an information handling system having a configuration of components selected from plural available components;
receiving from the user packaging preferences for the information handling system;
building the information handling system configured with the selected components; and
packaging the information handling system with the user packaging preferences.

10. The method of claim 9 further comprising:
determining packaging preferences for packaging information handling systems;
defining the packaging preferences as optional or required; and
presenting the optional packaging preferences to the user for selection.

11. The method of claim 10 wherein presenting the optional preferences further comprises presenting the option of including or excluding a recovery disc with the information handling system.

12. The method of claim 10 wherein receiving an order further comprises receiving an order for plural information handling systems and wherein presenting the optional preferences further comprises presenting the option of including or excluding a recovery disc with some but not all of the information handling systems.

13. The method of claim 10 wherein presenting the optional preferences further comprises presenting the option of including or excluding a user's manual with the information handling system.

14. The method of claim 10 wherein receiving an order further comprises receiving an order for plural information handling systems and wherein presenting the optional preferences further comprises presenting the option of including or excluding a user manual with some but not all of the information handling systems.

15. The method of claim 10 wherein the required packaging preferences comprise safety information.

16. The method of claim 10 further comprising:
saving the optional packaging preferences as a packaging policy associated with the user;
receiving a subsequent information handling system order associated with the user; and
automatically applying the packaging preference to the subsequent information handling system order.

17. The method of claim 10 further comprising:
presenting the user with a core packaging option having only the required packaging preferences.

18. The method of claim 10 wherein an optional packaging preference comprises including or excluding external media having one or more applications, the applications installed on a hard disc drive of the information handling system, each applications having a license key, the method further comprising:
making the license keys electronically available to the user if the external media is excluded.

19. The method of claim 10 further comprising:
determining that an electronic version exists of an optional packaging preference; and
making the electronic version available through the Internet if the user excludes the optional packaging preference.

20. The method of claim 19 wherein the optional packaging preference comprises a recovery medium and the electronic version comprises an image stored on a server information handling system.
